(19) United States
(12) Patent Application Publication
(10) Pub. No.: US 2020/0073352 A1
(43) Pub. Date: Mar. 5, 2020

(54) TECHNIQUES FOR ENABLING INTELLIGENT FUNCTIONALITY FOR NON-INTELLIGENT DEVICES

(71) Applicant: Intel Corporation, Santa Clara, CA (US)

(72) Inventors: Fan WANG, Shanghai (CN); Ting YE, Shanghai (CN)

(21) Appl. No.: 16/468,265

(22) PCT Filed: Jan. 11, 2017
(86) PCT No.: PCT/CN2017/070848

§ 371 Date: Jun. 10, 2019

(51) Int. Cl. G05B 19/042

(52) U.S. Cl. CPC G05B 19/0426; G05B 2219/2642

(57) ABSTRACT

Techniques for enabling intelligent functionalities for non-intelligent devices utilizing an intelligent kernel architecture are described. In some embodiments, a device obtains, responsive to being physically coupled with a second device via a physical interface, a device driver for the second device. The first device and the second device are detachable. The device receives one or more commands from a user to configure the second device to perform one or more actions. The device causes, over the physical interface using the device driver, the second device to perform the one or more actions according to the received command.

### TECHNICAL FIELD

The disclosure relates generally to electronics, and, more specifically, embodiments relate to techniques utilizing an intelligent kernel architecture for enabling intelligent functionalities for non-intelligent devices.

### BACKGROUND

In recent years, a move to make our homes and buildings “smart” has been widely focused upon as something that will benefit our daily lives. To this end, so-called “smart” devices play an important role in building the smart home. For example, the concept behind smart functionalities has led to the development of entirely new devices such as autonomous robotic vacuum cleaners and unmanned aerial vehicles (or “drones”). At the same time, many existing devices and gadgets commonly used by many people have been re-engineered as “smart” devices to add more intelligent functionalities. Among these devices, some are quite complex and/or expensive, such as air conditioners, refrigerators, or televisions, while some of these devices are comparatively inexpensive, such as a power socket, a light switch, a light bulb, electronic scale, etc.

A current approach to make traditional, unintelligent devices more intelligent is to embed a set of hardware inside the device such as a microchip (including one or more processors), a volatile and/or nonvolatile memory, wireless network interface, etc. However, this approach is problematic as it can involve adding substantial amounts of hardware to the device (which can thus increase the amount of physical footprint of the device) as well as adding substantial extra developmental costs and monetary costs to create these devices, which can completely overshadow the costs and/or footprint of the previous, often simpler unintelligent version of the device.

For example, intelligent light switches have been developed that can automatically turn on or off lights according to a static schedule or dynamic conditions, and electronic bathroom scales have been developed that can synchronize data with other devices, allowing for simplified health tracking. Although devices including these features certainly provide additional convenience and benefits, the features are likely to be viewed by consumers as “icing” on the cake—devices having them are “better” but those without them are still acceptable, especially when there is a substantial difference in cost, footprint, etc., between the intelligent and non-intelligent devices.

Another problem is that most of these new intelligent functionalities are used at a relatively low frequency. For example, robotic vacuum cleaners may be assigned a task every few days or even every few weeks, and most of time the devices remain inactive with nothing to do. As another example, electronic bathroom scales, though often used on a daily basis, do not necessarily need to synchronize weight data every single day. Accordingly, hardware waste is a problem, especially for inexpensive devices, and the cost to support new intelligent functionalities may be as much as the cost of the device itself.

Thus, producers may not create and consumers may not seek out devices with such intelligent functionalities and instead rely upon the traditional, non-intelligent versions of these devices. As a result, the continued manufacture and usage of non-intelligent devices collectively can result in substantial inefficiencies, such as energy waste (e.g., by powering an appliance unnecessarily when it could have instead been intelligently powered off, by heating or cooling a home unnecessarily, etc.), wasted time, etc.

Accordingly, techniques for implementing intelligent devices without substantial amounts of required physical components, design and manufacturing complexity, space, or cost are strongly desired.

### BRIEF DESCRIPTION OF THE DRAWINGS

The invention may best be understood by referring to the following description and accompanying drawings that are used to illustrate some embodiments. In the drawings:

FIG. 1 is a block diagram illustrating a system including an intelligent kernel of an intelligent kernel device providing “smart” functionalities for one or more unintelligent devices according to some embodiments.

FIG. 2 includes a variety of block diagrams illustrating various attachable and embedded intelligent kernel placement configurations according to some embodiments.

FIG. 3 is a block diagram illustrating a single intelligent kernel providing smart functionalities for multiple unintelligent devices according to some embodiments.

FIG. 4 is a block diagram illustrating exemplary user interactions with an intelligent kernel for controlling various devices according to some embodiments.

FIG. 5 is a block diagram illustrating an intelligent kernel device attached to a first consumer device and controlling both the first consumer device and a second consumer device according to some embodiments.

FIG. 6 is a flow diagram illustrating a flow of operations for configuring and utilizing an intelligent kernel device to provide smart functionalities for an unintelligent device according to some embodiments.

FIG. 7 is a flow diagram illustrating a flow of operations for providing smart functionalities for multiple devices while being attached to one of the multiple devices according to some embodiments.

FIG. 8 is a block diagram of a processor that may have more than one core, may have an integrated memory controller, and may have integrated graphics according to some embodiments.

FIGS. 9-12 are block diagrams of exemplary computer architectures, in which:

FIG. 9 is a block diagram of a system in accordance with some embodiments.

FIG. 10 is a block diagram of a first more specific exemplary system in accordance with some embodiments.

FIG. 11 is a block diagram of a second more specific exemplary system in accordance with some embodiments.

FIG. 12 is a block diagram of a System on a Chip (SoC) in accordance with some embodiments.

### DETAILED DESCRIPTION

The following description describes methods, apparatuses, computer-readable media, and systems for enabling intelligent functionalities for non-intelligent devices utilizing an intelligent kernel architecture. In this description, numerous specific details such as logic implementations, types and interrelationships of system components, etc., may be set forth in order to provide a more thorough understanding of some embodiments. It will be appreciated, however, by one skilled in the art that the invention may be practiced without such specific details. In other instances, control structures, gate level circuits, and/or full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

As indicated above, the creation, adoption, and utilization of intelligent devices is widely desired but hampered by problems such as increased manufacturing complexity, increased physical device footprint, increased use of components leading to increased costs, etc.

To reduce some of these costs, manufactures may attempt to simplify the architecture as much as possible, choose the most inexpensive software and/or hardware, etc. However, these optimizations have quite limited effects upon the ultimate cost of the device, and thus the fundamental problem is not addressed.

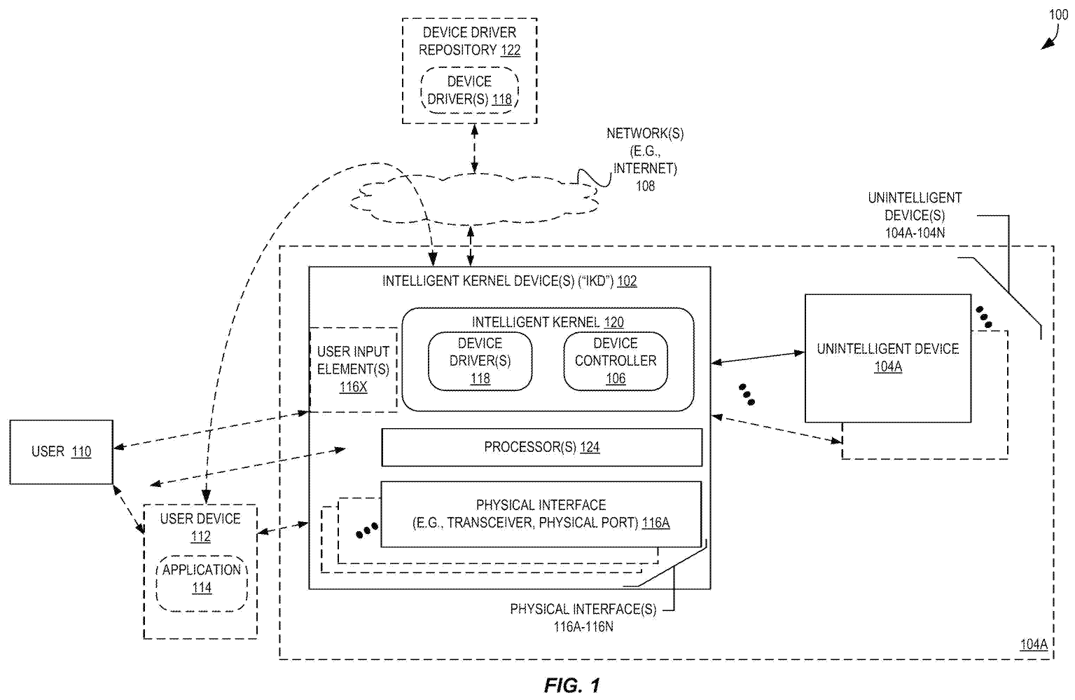

Accordingly, techniques for enabling intelligent functionalities (or “smart” functionality) for non-intelligent devices utilizing an intelligent kernel architecture are disclosed herein. FIG. 1 is a block diagram illustrating a system 100 including an intelligent kernel 120 implemented by an intelligent kernel device 102 (“IKD”) providing “smart” functionalities for one or more unintelligent (or non-smart) devices 104A-104N according to some embodiments.

As used herein, the terms “unintelligent” device 104A, “non-smart” device, or similar, may be used to commonly refer to devices that can perform a primary function (e.g., cooking food, controlling power to an appliance, vacuuming a floor, etc.) but that may not include a complete set of hardware needed to autonomously provider certain “smart” (or configurable) functionalities. For example, an unintelligent device may not include a processor, memory, etc., that would be used to provide smart functionalities—however, it is to be understood that these devices may still include these types of hardware (e.g., one or more processors), but that this hardware may instead be directed to performing the primary functions of the device, etc. Additionally, an unintelligent device may or may not be able to perform some “smart” functionalities on its own, but as described herein, it is to be understood that the device is not equipped to perform certain smart functionalities that can be provided (or enabled) via the intelligent kernel.

FIG. 1 includes an intelligent kernel 120 (e.g., a software module executed by one or more processors of an IKD 102) to implement a set of one or more intelligent functionalities via device controller 106, such as data computing, scheduling, reporting, remote control, etc., that can be used by one or more unintelligent devices 104A-104N, perhaps without adding any substantial developmental costs, physical footprint requirements, and/or hardware requirements to these devices. Thus, a user 110 can use the IDS 102 to control or configure the unintelligent devices 104A-104N, either directly via one or more user input elements 116X or indirectly via an application 114 (e.g., a web application presented via a web browser, a special-purpose application) executed by a user device 112 (e.g., a cellular phone, mobile device, laptop or personal computer), for example.

In some embodiments, the intelligent kernel 120 is implemented by a set of basic hardware elements (e.g., one or more processors 124, a volatile and/or non-volatile memory, one or more interfaces 116A-116N such as a network interface or other Input/Output (I/O) interface, one or more of which optionally could be one or more user input elements 116X such as buttons, a touchscreen, etc.) and can be “shared” by different devices 104A-104N—from one or multiple manufacturers—at the same or different times. Thus, in some embodiments, device manufactures need not integrate substantial hardware systems within the device to benefit from the intelligent kernel-provided functionalities, but instead, may simply design and construct the device to be able to connect to the intelligent kernel 120 and utilize the functionalities it provides.

In some embodiments, the intelligent kernel 120 can be implemented by an IKD 102 that can be physically attached to (e.g., as a “runnable and/or pluggable” device) the unintelligent device (e.g., 104A) via a physical interface (e.g., 116A) such as a physical port/interconnect. The specification of the physical interface 116A can be published or otherwise made known (e.g., standardized) so that a variety of unintelligent devices 104A-104N (potentially from a variety of manufacturers) can be coupled with the IKD 102.

The intelligent kernel 120 can be based upon, or include, any of a variety of existing software systems such as the Linux kernel or Unified Extensible Firmware Interface (UEFI) compliant firmware, which can allow for device drivers 118 (discussed later herein) for unintelligent devices 104A-104N to be easily created by developers, as existing and mature developmental tools and frameworks already exist that can be utilized for this purpose. The particular software implementing the intelligent kernel 120 can be selected based upon the type of work that may need to be performed in order to provide particular smart functionalities. For example, if an intelligent kernel 120 will likely need to perform a lot of computationally-intensive tasks, a version of the Linux kernel may be selected that provides multi-thread capabilities, though if an intelligent kernel 1200 will likely just need to do simple tasks, lighter-weight systems can be utilized.

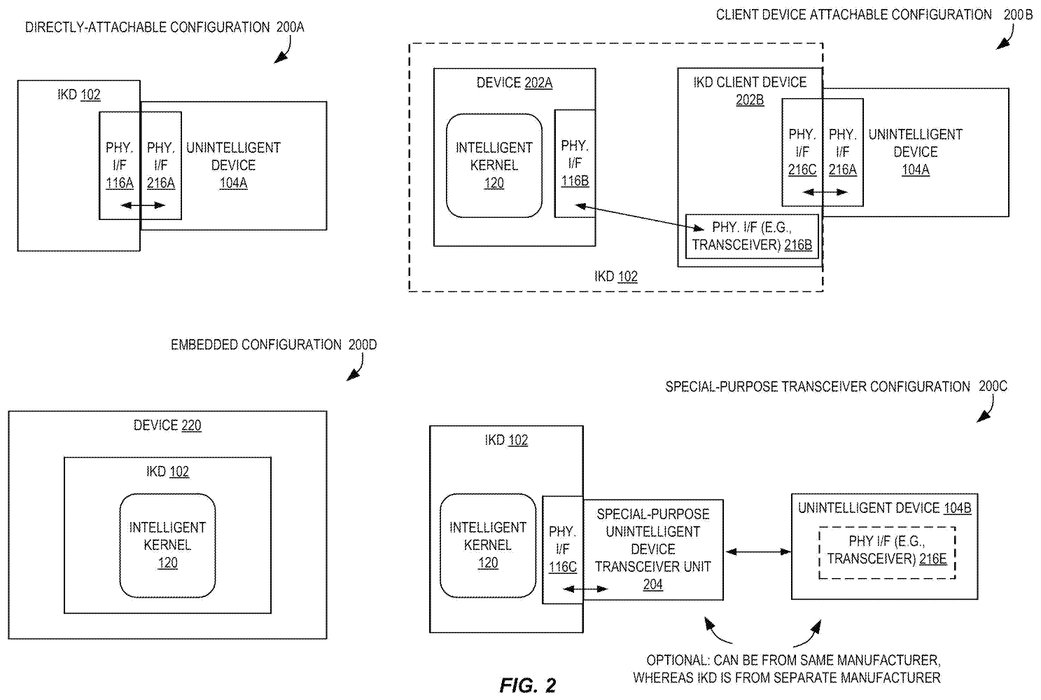

We now turn to FIG. 2, which includes a variety of block diagrams illustrating various attachable and embedded intelligent kernel placement configurations according to some embodiments.

As described herein, an unintelligent device 104A is able to be communicatively coupled with an intelligent kernel 120, which can occur by the unintelligent device 104A being adapted to be directly and physically attached to an IKD 102, and/or being adapted to be directly and physically attached (and communicatively coupled) with a transceiver device, etc., that itself is communicatively coupled with an IKD 102, etc.

The pairwise physical interface(s) of the unintelligent devices 104A-104N, in whatever form that they may be, in some embodiments may be the only thing the unintelligent devices 104A-104N need to integrate with to enable these intelligent functionalities. Thus, this interface may optionally be published so that it can be widely-known.

For example, a directly-attachable configuration 200A is illustrated to show how, in some embodiments, the IKD 102 may be directly physically attached (via its physical interface 116A) to an unintelligent device 104A (via its physical interface 216A). The physical interfaces 116A, 216A may of a variety of types of interfaces known to those of ordinary skill in the art, such as Universal Serial Bus (USB) type interfaces (e.g., receptacles), serial or parallel interface receptacles, Firewire, Ethernet, Thunderbolt (TM), or use a new or “custom” hardware interface allowing for communication between the connected devices.

As another example, a client device attachable configuration 200B is also illustrated in FIG. 2. In this configuration 200B, the intelligent kernel 120 may be “indirectly” attached to the unintelligent device 104A through use of multiple devices 202A-202B collectively forming the IKD 102. As shown, the intelligent kernel 120 may be implemented by a first device 202A, which may be communicatively coupled (e.g., via physical interface 116B) with a physical interface 216B of a second device 202B (or “IKD client device”). The second device 202B may then be physically attached, via physical interface 216C, to physical interface 216A of the unintelligent device 104A.

As yet another example, a special-purpose transceiver configuration 200C is shown that includes the IKD 102 being physically attached (at physical interface 116C) and thus communicatively coupled, with a special-purpose unintelligent device transceiver unit 204. The special-purpose unintelligent device transceiver unit 204 may be manufactured by the manufacturer of the unintelligent device 104B, and may be enabled to create a wireless communication channel (which may or may not be encrypted) between the special-purpose unintelligent device transceiver unit 204 and one or more unintelligent devices (e.g., unintelligent device 104B). For example, unintelligent device 104B can have a built-in physical interface 216E (e.g., a wireless transceiver) that can communicate with the special-purpose unintelligent device transceiver unit 204 using a mutually-agreed upon communication methodology. In some embodiments, the IKD 102 has one such physical interface 116C, but in other embodiments the IKD 102 has multiple physical interfaces 116C enabling the IKD 102 to communicate with multiple unintelligent devices in this manner.

As yet another example, an embedded configuration 200D is also shown with a device 220 that can have an embedded (or pre-attached, or attachable) IKD 102 including the intelligent kernel 120. This embedded configuration 200D can be particularly beneficial for a device manufacturer wanting to add “smart” functionalities to a device and benefit from substantially-reduced development costs, maintenance costs, etc., as the complexities involved regarding the “smart” part of the device 220 can be abstracted from the perspective of the manufacturer.

Accordingly, in these examples, only a limited amount of “additional” hardware (in addition to the “normal” hardware involved to perform the normal activity of the device) is utilized directly in/by the unintelligent devices 104A-104N, especially when compared to what is required for more typical smart devices produced today. Thus, in some embodiments most (or all) of the extra hardware needed for smart functionalities can thus be moved away from the unintelligent device, and instead encapsulated in IKD 102.

Moreover, in some embodiments the intelligent kernel 120 can be configured to be able to be “shared” by potentially multiple unintelligent devices 104A-104N, and as a result, the various types of “costs” (e.g., power, hardware footprint, financial) for enabling device-intelligence can be substantially reduced on a device-by-device basis, which can be especially beneficial for systems including simple, often-inexpensive devices such as light switches, power sockets, temperature/environmental sensors, etc.

Turning back to FIG. 1, at or after the time when the IKD 102 is attached to an unintelligent device 104A, a device driver 118 can be installed by the intelligent kernel 120 to allow the intelligent kernel 120 to determine know how to communicate with the device 104A, thus enabling the IDS 102 to provide (or enable) the device 104A with the intelligent functionalities.

A device driver (or “driver”) is a computer program that operates or controls a particular type of device. Thus, device drivers 118 provide a software interface to hardware devices, from which a software module (e.g., the device controller 106 of the intelligent kernel 120) to access hardware functions without needing to know the precise details of the hardware being used or specifically how exactly to cause the device to perform those operations. Typically, a device driver 118 communicates with the corresponding device through a bus or communications subsystem to which the hardware connects—e.g., physical interface 116A. Thus, when the intelligent kernel 120 (or other program) invokes a routine (e.g., a function, procedure) provided by the device driver 118, the device driver may issue commands to the unintelligent device 104A. The unintelligent device 104A may send data back to the device driver 118 (over the physical interface 116A), which can thus send data back to the intelligent kernel 120 (or invoke routines in the intelligent kernel 120).

The device driver 118, which can be specific for a particular unintelligent device 104A (e.g., specific for a particular model of a device) or specific for a group of unintelligent devices 104A-104N (e.g., a group of devices from a same manufacturer, a group of devices implemented in a common manner).

The device driver 118 can be obtained by the IKD 102 in a variety of ways. As one example, in some embodiments upon the IKD 102 becoming physically connected/attached to an unintelligent device 104A via a physical interface 116A, the unintelligent device 104A may be configured to provide a copy of its device driver 118 (e.g., which could be stored in a Read Only Memory (ROM), or other data storage device of the unintelligent device 104A) directly to the IKD 102, perhaps via the same physical interface 116A that connects the two. This providing of a copy of the device driver 118 may occur, for example, during a communications “handshake” between the two devices, or could occur responsive to the IKD 102 transmitting a request message (indicating a request for the device driver 118) via the physical interface 116A.

In some embodiments, the IKD 102 may obtain a device identifier of the unintelligent device 104A (e.g., during a handshake after becoming attached). The IKD 102 can use this device identifier to thus obtain the device driver 118 from another location. For example, in some embodiments, the IKD 102 can obtain the device identifier (e.g., over the physical interface from the unintelligent device 104A) and transmit a request for the device driver (e.g., which can include or be based upon the device identifier) over one or more networks 108 (e.g., the Internet) to a device driver repository 122. In response, the device driver repository 122 may identify and transmit back the requested device driver 118.

Additionally, in some embodiments the IKD 102 can obtain a device driver 118 for the unintelligent device 104A from a user device 112 of the user 110. For example, the user 110 may plug in (or attach) the IKD 102 to the unintelligent device 104A, and may (earlier, at the same time, or afterward) use an application 114 to cause the device driver 118 to be provided to the IKD 102. For example, the user 110 may use user device 112 to download the device driver 118 from a source reachable over the Internet (e.g., networks 108), and thereafter cause user device 112 to transmit the device driver 118 to the IKD 102.

Of course, many other possibilities for obtaining the proper device driver 118 are known or derivable by those of ordinary skill in the art, and can include, for example, the IKD 102 being pre-loaded with a plurality of device drivers 118 and then identifying one of these device drivers 118 to be used (e.g., based upon a device identifier of the particular unintelligent device 104A, based upon a selection made by a user 110).

The device controller 106 of the intelligent kernel 120 can thus utilize the device driver 118 to control the unintelligent device(s) 104A-104N. The device driver 118 can include a variety of routines, such as a routine to “start” or “power on” the unintelligent device 104A, “stop” or “power off” the unintelligent device 104A, report back an operating status or condition of the unintelligent device 104A (e.g., a battery level, an error code), report back a schedule of the unintelligent device 104A, etc.

In some embodiments, the intelligent kernel 120 may enable a user 110 to control how the unintelligent device 104A is to perform intelligent operations. For example, an application 114 (e.g., a web browser loading a web application served by the IKD 102, a standalone app that can send commands to the intelligent kernel 120) may allow the user 110 to select or program intelligent operations for the unintelligent device 104A or for multiple unintelligent devices 104A-104N.

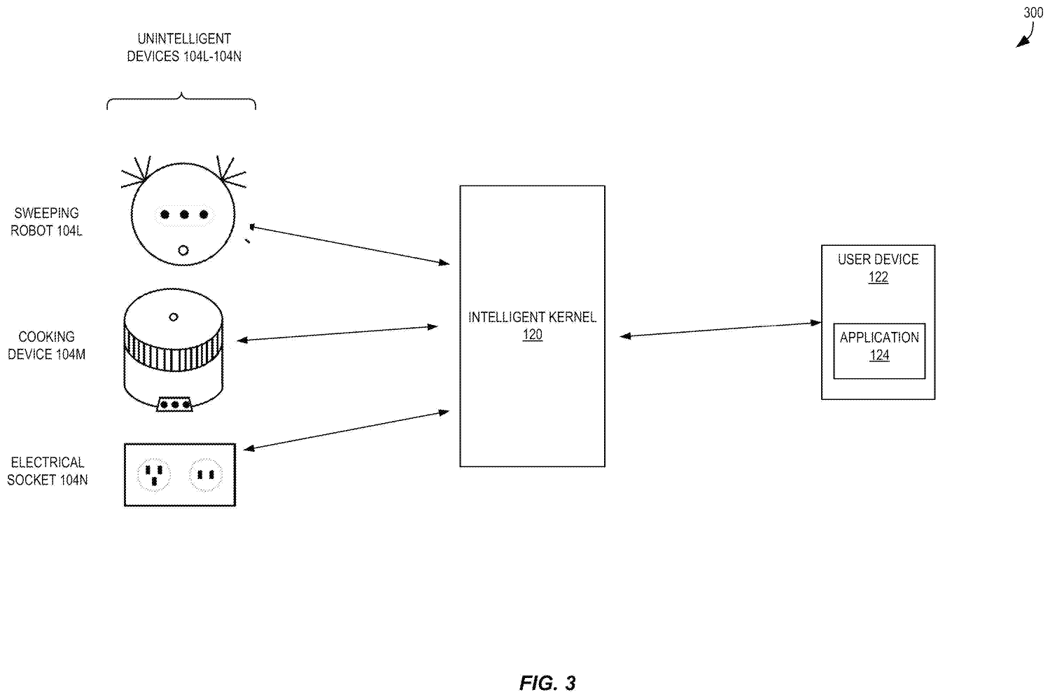

We now turn to FIG. 3, which is a block diagram illustrating a system 300 including a single intelligent kernel 120 that provides smart functionalities for multiple unintelligent devices according to some embodiments. This figure illustrates an example of how to the intelligent kernel 120 can be used in a person's daily life. This figures shows three unintelligent devices 104L-104N that are provided with intelligent functionalities by the intelligent kernel 120: an electrical socket 104N, a cooking device 104M (e.g., a rice cooker, a slow cooker, a pressure cooker, a microwave), and a sweeping robot 104L (e.g., a robot vacuum). The electrical socket 104N may have a timer hardware element inside, which can be exposed via its device driver, allowing it to be used in different periods of time via the intelligent kernel 120. For example, a user may typically leave their home at 8:00 AM, and have such an expectation that their dinner can be fully cooked (e.g., by cooking device 104M) before the user arrives back home at 6:00 PM. After this meal, the user may want the sweeping robot 104L to automatically clean the dining room area. Additionally, before the user goes to sleep for the evening, the user may wish to charge their cellular phone (e.g., user device 122) via electrical socket 104N and also have the electrical socket 104N turn off when the charging process ends. This sequence of operations can be configured, by the user, using an application 124 that can provide the desired sequence of operations (or an indication thereof) to the intelligent kernel 120, which can use its device drivers 118 for the unintelligent devices 104L-104N to effect the operations.

For example, to create the above-described sequence, the user could configure the intelligent kernel 120 (e.g., using an application 124 of user device 122) to have (1) the electrical socket 104N turn itself off at 8:00 AM (when the user leaves for the day) to avoid any energy waste from so-called “zombie” devices plugged in, (2) the cooking device 104M turn itself on and begin cooking at 5:00 PM (before the user arrives home, to allow sufficient time to cook a meal), (3) the sweeping robot 104L turn itself on and begin cleaning the floor 30 minutes after the cooking device 104M has been turned off by the user, (4) the electrical socket 104N ensure that it is turned on at 9:00 PM, and even (5) turn off the electrical socket 104N at a particular time (e.g., 3:00 AM) or based upon another event occurring (e.g., the user device 122 reporting to the intelligent kernel 120 that its battery is fully charged).

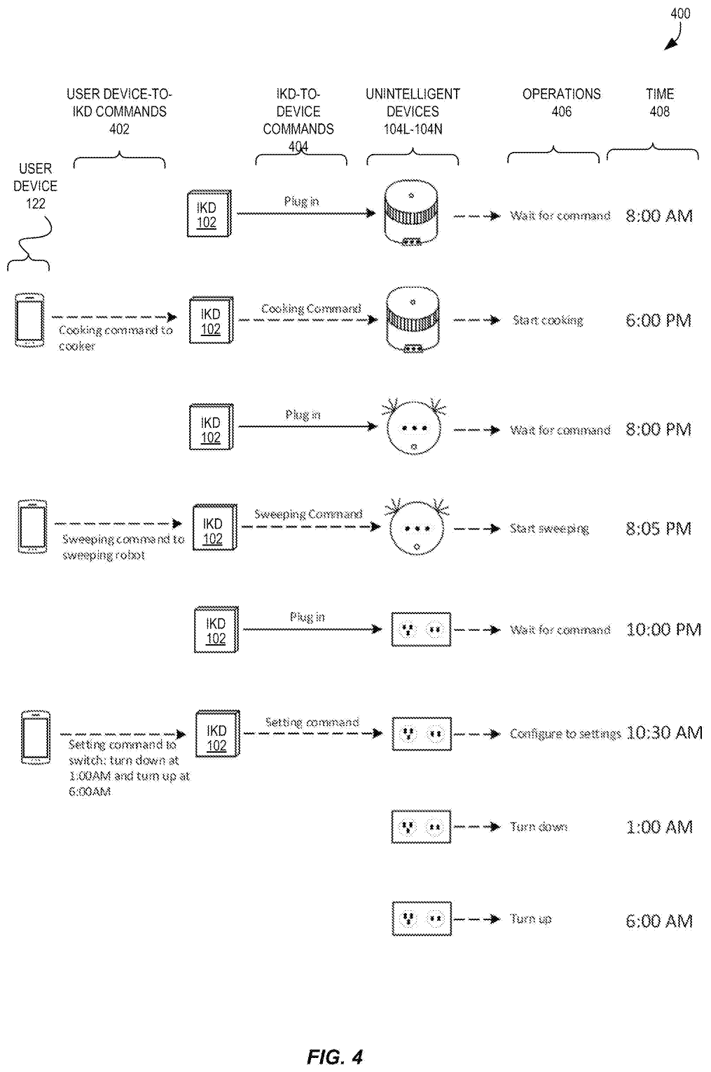

Of course, many other ways to implement such intelligent functionalities exist. For example, consider FIG. 4, which is a block diagram illustrating exemplary user interactions with an intelligent kernel for controlling various devices to perform certain operations 406 at certain times 408 according to some embodiments. This example shows how the user may cause certain ones of the unintelligent devices 104L-104N to perform intelligent operations in both an “on demand” basis and on a “scheduled” basis remotely via user device 122. In this example, the user device 122 may transmit commands 402 to the IKD 102, such as a first command to cause the cooking device 104M to begin cooking at 6:00 PM, a second command to cause the sweeping robot 104L to begin sweeping the floor at 8:05 PM, a third command to perform multiple operations including turning off the electrical socket 104N at 1:00 AM and turning on the electrical socket 104N at 6:00 AM. As shown, the IKD 102 can implement each of these commands using one (or many) of its own commands 404 to the unintelligent devices 104A-104N—of course, these are merely exemplary and there are many other ways to implement this functionality known to those of skill in the art.

As discussed above, in some embodiments, an intelligent kernel 120 can enable intelligent functionalities for multiple unintelligent devices 104A-104N. Further, the intelligent kernel 120 can also cause different unintelligent devices 104A-104N to perform operations based upon the operations of others of the unintelligent devices 104A-104N.

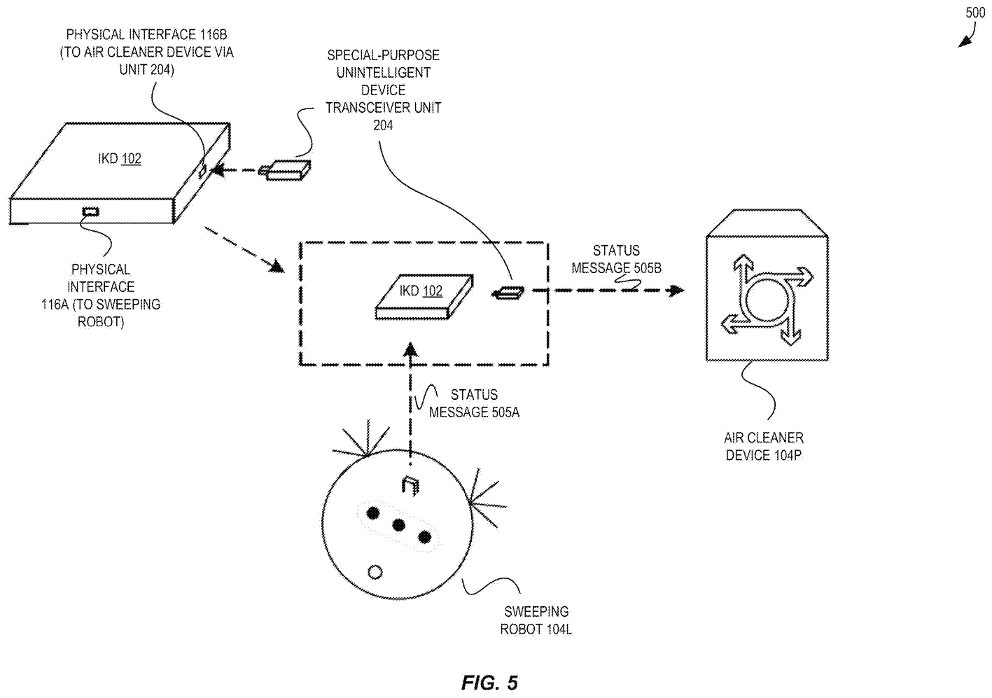

For example, FIG. 5 is a block diagram illustrating an intelligent kernel device 102 that is physically attached to a first unintelligent device (i.e., sweeping robot 104L) yet controls both the first unintelligent device and a second consumer device (i.e., air cleaner device 104P) according to some embodiments. Accordingly, embodiments can integrate more than one interface with one intelligent kernel to allow for device cooperation. For example, if the function interface of a device is published or provided to other devices, other devices can “operate” (or interact with) that device when these devices are working on the same platform.

Thus, FIG. 4 shows that an IKD 102 may be physically connected/attached to a sweeping robot 104L, while the IKD 102 is also attached with a signal receiver (i.e., special-purpose unintelligent device transceiver unit 204) of the air cleaner device 104P. Thus, the air cleaner device 104P may be operable to use the intelligent kernel's 120 abilities in a “remote” fashion. For example, the air cleaner device 104P may be configured to monitor the operations of the sweeping robot 104L, and when the sweeping robot 104L has completed a cleaning cycle, the air cleaner device 104P may turn itself on at that point. This can be achieved in a variety of ways, including having the air cleaner device 104P periodically (e.g., every minute) call the sweeping robot's 104L function interface to get its status (as status messages 505A, 505B). Then, when the sweeping robot 104L finishes its work, the air cleaner device 104P can detect the change in the operating status of the sweeping robot 104L and start its job.

Of course, this functionality can be implemented in a variety of other ways, including having the IKD 102 monitor the status of the sweeping robot 104L, and upon the completion of its cleaning job, use the device driver of the air cleaner device 104P to cause it to operate.

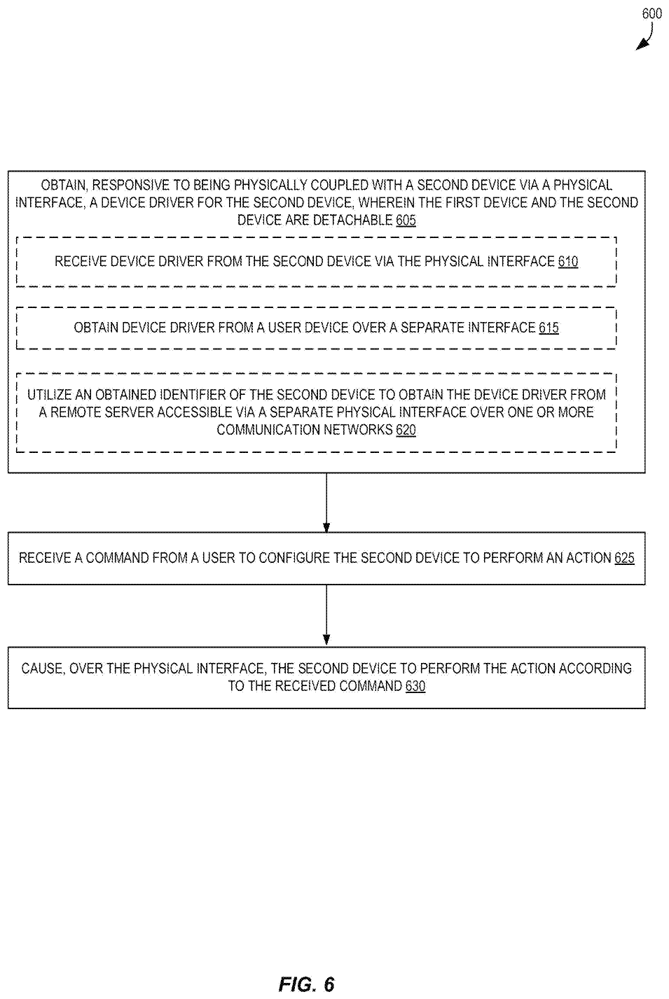

FIG. 6 is a flow diagram illustrating a flow 600 of operations for configuring and utilizing an IKD 102 to provide smart functionalities for an unintelligent device 104A according to some embodiments. The operations in the flow diagrams will be described with reference to the exemplary embodiments of the other figures. However, it should be understood that the operations of the flow diagrams can be performed by embodiments other than those discussed with reference to the other figures, and the embodiments discussed with reference to these other figures can perform operations different than those discussed with reference to the flow diagrams. In some embodiments, the flow 600 is performed by a “first device,” which could be the IKD 102.

Flow 600 includes, at block 605, obtaining, responsive to being physically coupled with a second device via a physical interface, a device driver for the second device. The first device and the second device are detachable. Block 605 can optionally include block 610 and receiving the device driver from the second device via the physical interface. Block 605 can optionally include obtaining the device driver from a user device over a separate interface. Block 605 can optionally include utilizing an obtained identifier of the second device to obtain the device driver from a remote server accessible via a separate physical interface over one or more communication networks.

Flow 600 also includes, at block 625, receiving a command from a user to configure the second device to perform an action.

Flow 600 also includes, at block 630, causing, over the physical interface, the second device to perform the action according to the received command.

### Examples

In some embodiments, a method can be performed by a first device for providing smart functionality to a second device. The method includes obtaining, by the first device responsive to being physically coupled with the second device via a physical interface, a device driver for the second device. The first device and the second device are detachable. The method also includes receiving, by the first device, one or more commands from a user to configure the second device to perform one or more actions. The method also includes causing, by the first device over the physical interface using the device driver, the second device to perform the one or more actions according to the received command.

In some embodiments, obtaining the device driver comprises receiving, by the first device via the physical interface of the second device, the device driver for the second device.

In some embodiments, obtaining the device driver comprises receiving, at the first device via a separate interface, the device driver for the second device. In some embodiments, the separate interface is a wireless network interface, and the device driver for the second device is received from a user device of the user. In some embodiments, the received one or more commands from the user are received from the user device of the user via the wireless network interface, and the one or more commands were originated by the user device responsive to the user utilizing an application executed by the user device allowing the user to control the second device.

In some embodiments, obtaining the device driver comprises obtaining, by the first device, an identifier of the second device; transmitting, by the first device via a separate interface, a request message carrying a request for the device driver, wherein the request includes the identifier of the second device; and receiving, at the first device via the separate interface, the device driver for the second device.

In some embodiments, the second device is a consumer device that does not include a processor. In some embodiments, the second device is manufactured by a separate entity than an entity that manufactured the first device.

In some embodiments, the method further includes receiving, by the first device, one or more additional commands from the user to configure a third device to perform one or more additional actions, wherein the one or more additional actions are to be performed by the third device at a time as when the second device performs the one or more actions or after the time when the second device performs the one or more actions; and causing, by the first device over a wireless interface, the third device to perform the one or more additional actions at or after the time according to the received one or more additional commands.

In some embodiments, the first device further comprises one or more user input elements allowing the user to provide user input to the first device, and the one or more commands are received from the user via the one or more user input elements.

According to some embodiments, a non-transitory computer-readable storage medium has instructions which, when executed by one or more processors of a first device, cause the first device to provide smart functionality to a second device by performing operations. The operations include obtaining, responsive to being physically coupled with the second device via a physical interface, a device driver for the second device, wherein the first device and the second device are detachable; receiving one or more commands from a user to configure the second device to perform one or more actions; and causing, over the physical interface using the device driver, the second device to perform the one or more actions according to the received command.

In some embodiments, obtaining the device driver comprises receiving via the physical interface of the second device, the device driver for the second device.

In some embodiments, obtaining the device driver comprises receiving, via a separate interface, the device driver for the second device. In some embodiments, the separate interface is a wireless network interface, and the device driver for the second device is received from a user device of the user. In some embodiments, the received one or more commands from the user are received from the user device of the user via the wireless network interface, wherein the one or more commands were originated by the user device responsive to the user utilizing an application executed by the user device allowing the user to control the second device.

In some embodiments, obtaining the device driver comprises obtaining an identifier of the second device; transmitting, via a separate interface, a request message carrying a request for the device driver, wherein the request includes the identifier of the second device; and receiving, via the separate interface, the device driver for the second device.

According to some embodiments, a first device is to provide smart functionality to a second device. The first device includes a physical interface to physically and communicatively couple the first device with a second device, wherein the first device and the second device are detachable; one or more processors; and a non-transitory computer-readable storage medium having instructions which, when executed by the one or more processors, cause the first device to perform operations. The operations include obtaining, responsive to being physically coupled with the second device via the physical interface, a device driver for the second device; receiving one or more commands from a user to configure the second device to perform one or more actions; and causing, over the physical interface using the device driver, the second device to perform the one or more actions according to the received command.

In some embodiments, obtaining the device driver comprises receiving via the physical interface of the second device, the device driver for the second device.

In some embodiments, obtaining the device driver comprises receiving, via a separate interface, the device driver for the second device. In some embodiments, the separate interface is a wireless network interface, and the device driver for the second device is received from a user device of the user. In some embodiments, the received one or more commands from the user are received from the user device of the user via the wireless network interface, wherein the one or more commands were originated by the user device responsive to the user utilizing an application executed by the user device allowing the user to control the second device.

In some embodiments, obtaining the device driver comprises obtaining an identifier of the second device; transmitting, via a separate interface, a request message carrying a request for the device driver, wherein the request includes the identifier of the second device; and receiving, via the separate interface, the device driver for the second device.

In some embodiments, the operations further comprise receiving one or more additional commands from the user to configure a third device to perform one or more additional actions, wherein the one or more additional actions are to be performed by the third device at a time as when the second device performs the one or more actions or after the time when the second device performs the one or more actions; and causing, over a wireless interface, the third device to perform the one or more additional actions at or after the time according to the received one or more additional commands.

According to some embodiments, a first device is to provide smart functionality to a second device. The first device includes means for obtaining, responsive to being physically coupled with the second device via a physical interface, a device driver for the second device, wherein the first device and the second device are detachable. The first device also includes means for receiving one or more commands from a user to configure the second device to perform one or more actions. The first device also includes means for causing, over the physical interface using the device driver, the second device to perform the one or more actions according to the received command.

According to some embodiments, a system includes a first device. The first device comprises a first physical interface that physically and communicatively couples the first device with a second device, and the first device and the second device are detachable; one or more processors; and a non-transitory computer-readable storage medium having instructions which, when executed by the one or more processors, cause the first device to perform operations. The operations include obtaining, responsive to being physically coupled with the second device via the first physical interface, a device driver for the second device; receiving one or more commands from a user to configure the second device to perform one or more actions; and causing, over the first physical interface using the device driver, the second device to perform the one or more actions according to the received command.

In yet another embodiment, an apparatus comprises a data storage device that stores code that when executed by a hardware processor causes the hardware processor to perform any method disclosed herein. An apparatus may be as described in the detailed description. A method may be as described in the detailed description.

In another embodiment, a non-transitory machine-readable medium that stores code that when executed by a machine causes the machine to perform a method comprising any method disclosed herein.

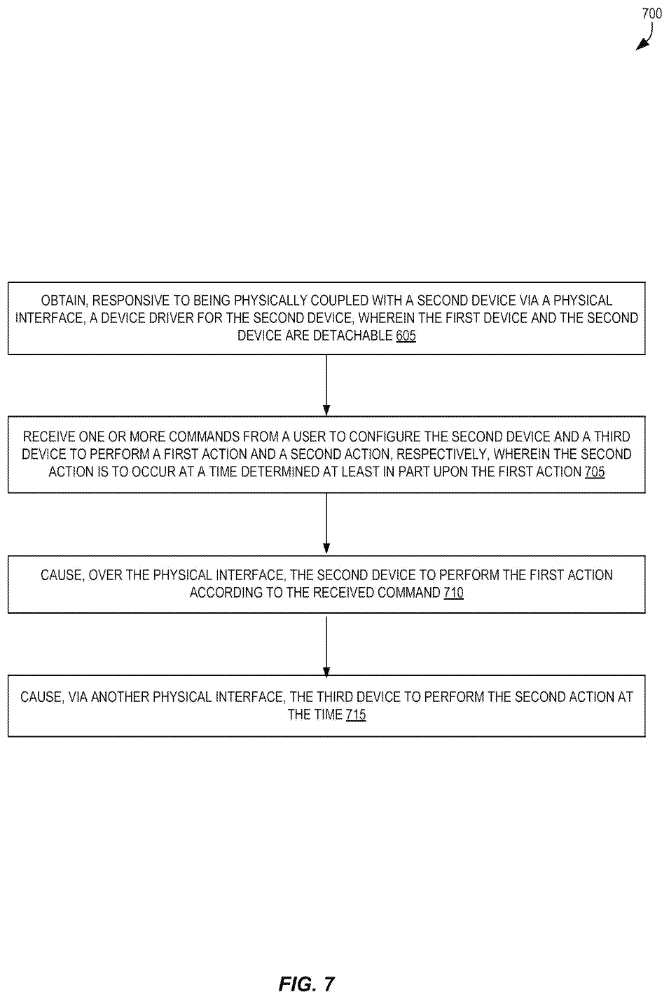

FIG. 7 is a flow diagram illustrating a flow 700 of operations for providing smart functionalities for multiple devices while being attached to one of the multiple devices according to some embodiments. In some embodiments, the flow 700 is performed by a “first device,” which could be the IKD 102.

Flow 700 includes, at block 605, obtaining, responsive to being physically coupled with a second device via a physical interface, a device driver for the second device. The first device and the second device are detachable.

Flow 700 also includes, at block 705, receiving one or more commands from a user to configure the second device and a third device to perform a first action and a second action, respectively. The second action is to occur at a time determined at least in part upon the first action.

Flow 700 also includes, at block 710, causing, over the physical interface, the second device to perform the first action according to the received command.

Flow 700 also includes, at block 715, causing, via another physical interface, the third device to perform the second action at the time.

Embodiments disclosed herein utilize electronic devices. An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment may be implemented using different combinations of software, firmware, and/or hardware.

### Exemplary Processor

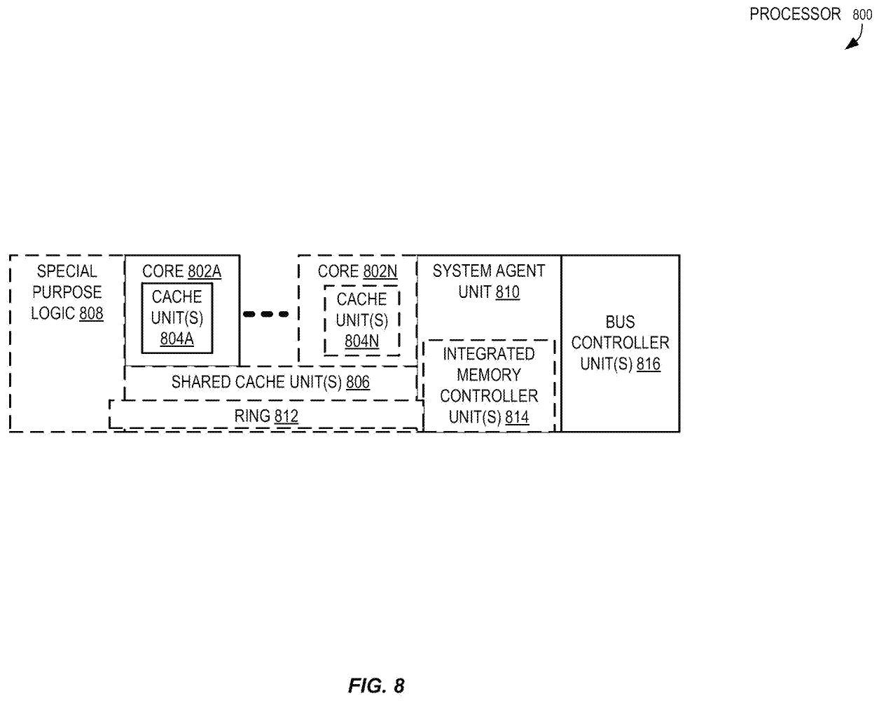

FIG. 8 is a block diagram of a processor 800 that may have more than one core, may have an integrated memory controller, and may have integrated graphics according to some embodiments. The solid lined boxes in FIG. 8 illustrate a processor 800 with a single core 802A, a system agent 810, a set of one or more bus controller units 816, while the optional addition of the dashed lined boxes illustrates an alternative processor 800 with multiple cores 802A-802N, a set of one or more integrated memory controller unit(s) 814 in the system agent unit 810, and special purpose logic 808.

Thus, different implementations of the processor 800 may include: 1) a CPU with the special purpose logic 808 being integrated graphics and/or scientific (throughput) logic (which may include one or more cores), and the cores 802A-802N being one or more general purpose cores (e.g., general purpose in-order cores, general purpose out-of-order cores, a combination of the two); 2) a coprocessor with the cores 802A-802N being a large number of special purpose cores intended primarily for graphics and/or scientific (throughput); and 3) a coprocessor with the cores 802A-802N being a large number of general purpose in-order cores. Thus, the processor 800 may be a general-purpose processor, coprocessor or special-purpose processor, such as, for example, a network or communication processor, compression engine, graphics processor, general purpose graphics processing unit (GPGPU), a high-throughput many integrated core (MIC) coprocessor (e.g., including 30 or more cores), embedded processor, or the like. The processor may be implemented on one or more chips. The processor 800 may be a part of and/or may be implemented on one or more substrates using any of a number of process technologies, such as, for example, Complementary metal-oxide-semiconductor (CMOS), BiCMOS, or N-type metal-oxide-semiconductor (NMOS).

The memory hierarchy includes one or more levels of cache within the cores, a set or one or more shared cache units 806, and external memory (not shown) coupled to the set of integrated memory controller units 814. The set of shared cache units 806 may include one or more mid-level caches, such as level 2 (L2), level 3 (L3), level 4 (L4), or other levels of cache, a last level cache (LLC), and/or combinations thereof. While in some embodiments a ring based interconnect unit 812 interconnects the special purpose logic 808 (e.g., integrated graphics logic), the set of shared cache units 806, and the system agent unit 810/integrated memory controller unit(s) 814, alternative embodiments may use any number of well-known techniques for interconnecting such units. In some embodiments, coherency is maintained between one or more cache units 806 and cores 802A-802N.

In some embodiments, one or more of the cores 802A-802N are capable of multi-threading. The system agent 810 includes those components coordinating and operating cores 802A-802N. The system agent unit 810 may include for example a power control unit (PCU) and a display unit. The PCU may be or include logic and components needed for regulating the power state of the cores 802A-802N and the integrated graphics logic 808. The display unit is for driving one or more externally connected displays.

The cores 802A-802N may be homogenous or heterogeneous in terms of architecture instruction set; that is, two or more of the cores 802A-802N may be capable of execution the same instruction set, while others may be capable of executing only a subset of that instruction set or a different instruction set.

### Exemplary Computer Architectures

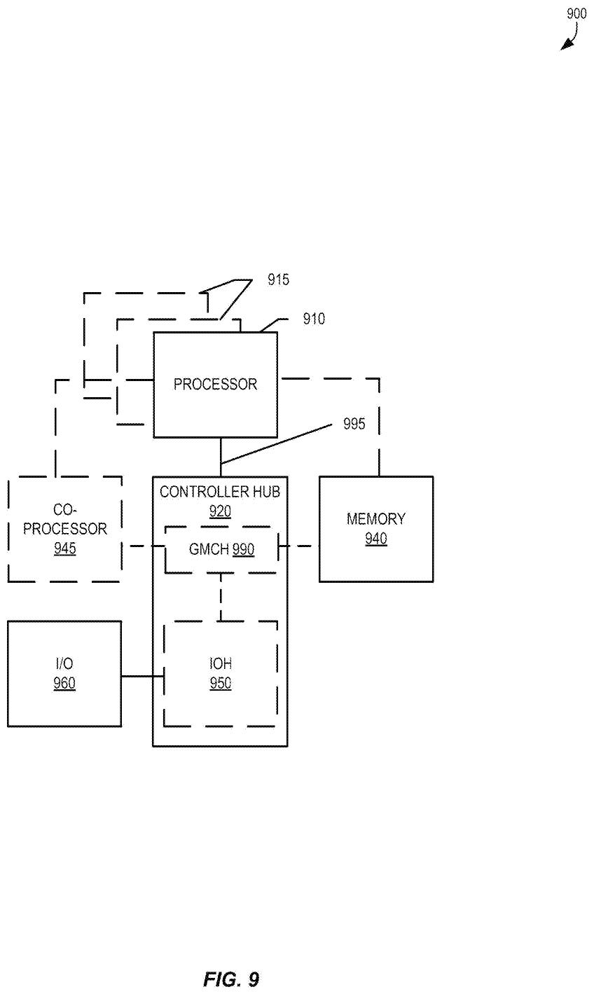

FIGS. 9-12 are block diagrams of exemplary computer architectures. Other system designs and configurations known in the arts for laptops, desktops, handheld personal computers (PCs), personal digital assistants (PDAs), engineering workstations, servers, network devices, network hubs, switches, embedded processors, digital signal processors (DSPs), graphics devices, video game devices, set-top boxes (STBs), micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 9, shown is a block diagram of a system 900 in accordance with some embodiments. The system 900 may include one or more processors 910, 915, which are coupled to a controller hub 920. In some embodiments the controller hub 920 includes a graphics memory controller hub (GMCH) 990 and an Input/Output Hub (IOH) 950 (which may be on separate chips); the GMCH 990 includes memory and graphics controllers to which are coupled memory 940 and a coprocessor 945; the IOH 950 couples input/output (I/O) devices 960 to the GMCH 990. Alternatively, one or both of the memory and graphics controllers are integrated within the processor (as described herein), the memory 940 and the coprocessor 945 are coupled directly to the processor 910, and the controller hub 920 in a single chip with the IOH 950.

The optional nature of additional processors 915 is denoted in FIG. 9 with broken lines. Each processor 910, 915 may include one or more of the processing cores described herein and may be some version of the processor 800.

The memory 940 may be, for example, dynamic random access memory (DRAM), phase change memory (PCM), or a combination of the two. In some embodiments, the controller hub 920 communicates with the processor(s) 910, 915 via a multi-drop bus, such as a frontside bus (FSB), point-to-point interface such as QuickPath Interconnect (QPI), or similar connection 995.

In some embodiments, the coprocessor 945 is a special-purpose processor, such as, for example, a high-throughput MIC processor, a network or communication processor, compression engine, graphics processor, GPGPU, embedded processor, or the like. In some embodiments, controller hub 920 may include an integrated graphics accelerator.

There can be a variety of differences between the physical resources 910, 915 in terms of a spectrum of metrics of merit including architectural, microarchitectural, thermal, power consumption characteristics, and the like.

In some embodiments, the processor 910 executes instructions that control data processing operations of a general type. Embedded within the instructions may be coprocessor instructions. The processor 910 recognizes these coprocessor instructions as being of a type that should be executed by the attached coprocessor 945. Accordingly, the processor 910 issues these coprocessor instructions (or control signals representing coprocessor instructions) on a coprocessor bus or other interconnect, to coprocessor 945. Coprocessor(s) 945 accepts and executes the received coprocessor instructions.

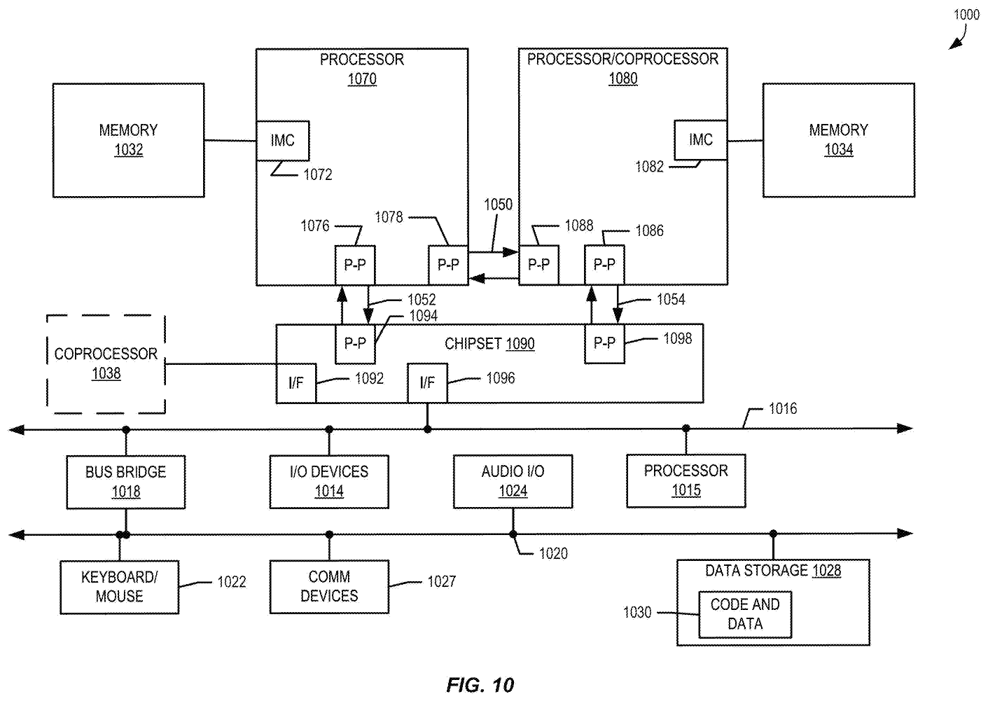

Referring now to FIG. 10, shown is a block diagram of a first more specific exemplary system 1000 in accordance with some embodiments. As shown in FIG. 10, multiprocessor system 1000 is a point-to-point interconnect system, and includes a first processor 1070 and a second processor 1080 coupled via a point-to-point interconnect 1050. Each of processors 1070 and 1080 may be some version of the processor 800. In some embodiments, processors 1070 and 1080 are respectively processors 910 and 915, while coprocessor 1038 is coprocessor 945. In another embodiment, processors 1070 and 1080 are respectively processor 910 coprocessor 945.

Processors 1070 and 1080 are shown including integrated memory controller (IMC) units 1072 and 1082, respectively. Processor 1070 also includes as part of its bus controller units point-to-point (P-P) interfaces 1076 and 1078; similarly, second processor 1080 includes P-P interfaces 1086 and 1088. Processors 1070, 1080 may exchange information via a point-to-point (P-P) interface 1050 using P-P interface circuits 1078, 1088. As shown in FIG. 10, IMCs 1072 and 1082 couple the processors to respective memories, namely a memory 1032 and a memory 1034, which may be portions of main memory locally attached to the respective processors.

Processors 1070, 1080 may each exchange information with a chipset 1090 via individual P-P interfaces 1052, 1054 using point to point interface circuits 1076, 1094, 1086, 1098. Chipset 1090 may optionally exchange information with the coprocessor 1038 via a high-performance interface 1092. In some embodiments, the coprocessor 1038 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1090 may be coupled to a first bus 1016 via an interface 1096. In some embodiments, first bus 1016 may be a Peripheral Component Interconnect (PCI) bus, or a bus such as a PCI Express bus or another third generation I/O interconnect bus, although the scope of the present invention is not so limited.

As shown in FIG. 10, various I/O devices 1014 may be coupled to first bus 1016, along with a bus bridge 1018 which couples first bus 1016 to a second bus 1020. In some embodiments, one or more additional processor(s) 1015, such as coprocessors, high-throughput MIC processors, GPGPUs, accelerators (such as, e.g., graphics accelerators or digital signal processing (DSP) units), field programmable gate arrays (FPGAs), or any other processor, are coupled to first bus 1016. In some embodiments, second bus 1020 may be a low pin count (LPC) bus. Various devices may be coupled to a second bus 1020 including, for example, a keyboard and/or mouse 1022, communication devices 1027 and a storage unit 1028 such as a disk drive or other mass storage device which may include instructions/code and data 1030, in some embodiments. Further, an audio I/O 1024 may be coupled to the second bus 1020. Note that other architectures are possible. For example, instead of the point-to-point architecture of FIG. 10, a system may implement a multi-drop bus or other such architecture.

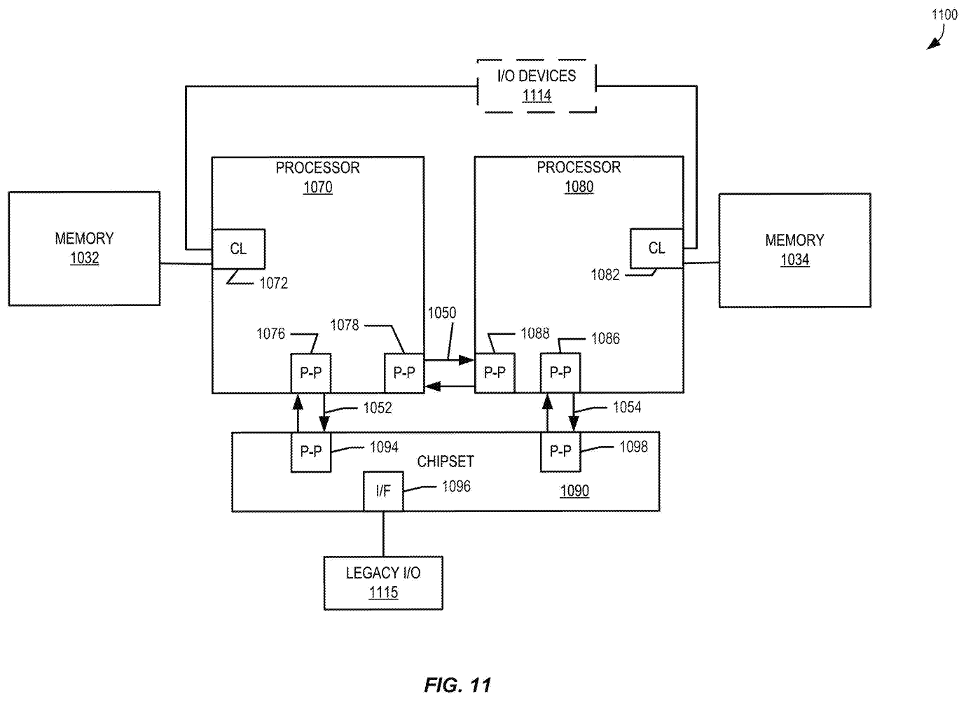

Referring now to FIG. 11, a block diagram of a second more specific exemplary system 1100 is illustrated in accordance with some embodiments. Like elements in FIGS. 10 and 11 bear like reference numerals, and certain aspects of FIG. 10 have been omitted from FIG. 11 in order to avoid obscuring other aspects of FIG. 11.

FIG. 11 illustrates that the processors 1070, 1080 may include integrated memory and I/O control logic (“CL”) 1072 and 1082, respectively. Thus, the CL 1072, 1082 include integrated memory controller units and include I/O control logic. FIG. 11 illustrates that not only are the memories 1032, 1034 coupled to the CL 1072, 1082, but also that I/O devices 1114 are also coupled to the control logic 1072, 1082. Legacy I/O devices 1115 are coupled to the chipset 1090.

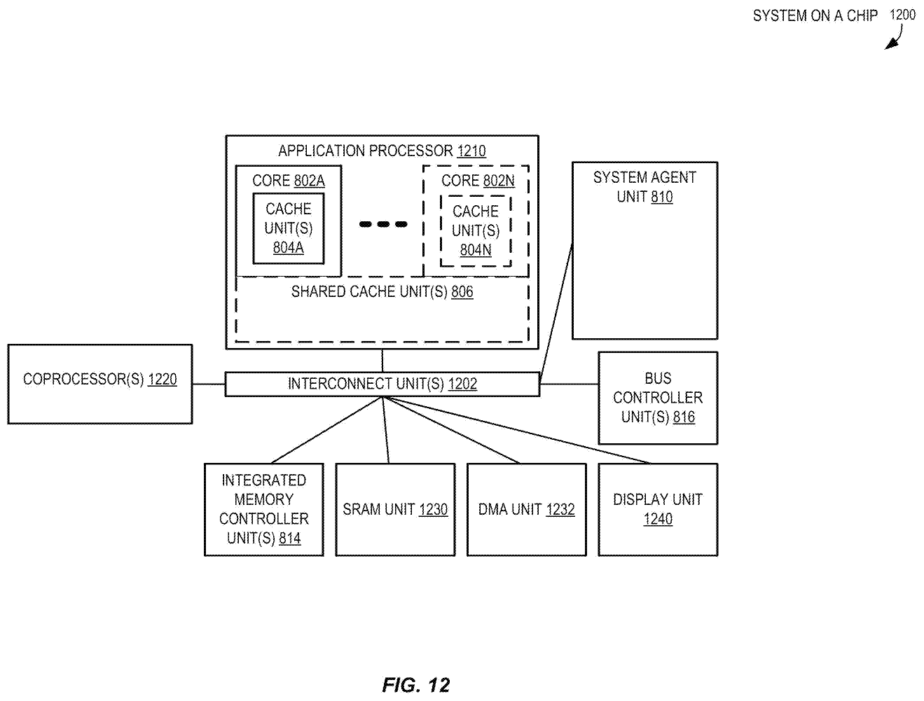

Referring now to FIG. 12, shown is a block diagram of a SoC 1200 in accordance with an embodiment of the present invention. Similar elements in FIG. 8 bear like reference numerals. Also, dashed lined boxes are optional features on more advanced SoCs. In FIG. 12, an interconnect unit(s) 1202 is coupled to: an application processor 1210 which includes a set of one or more cores 802A-802N, which include cache units 804A-N, and shared cache unit(s) 806; a system agent unit 810; a bus controller unit(s) 816; an integrated memory controller unit(s) 814; a set or one or more coprocessors 1220 which may include integrated graphics logic, an image processor, an audio processor, and a video processor; an static random access memory (SRAM) unit 1230; a direct memory access (DMA) unit 1232; and a display unit 1240 for coupling to one or more external displays. In some embodiments, the coprocessor(s) 1220 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1030 illustrated in FIG. 10, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least some embodiments may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

Though the flow diagrams in the figures show a particular order of operations performed by certain embodiments, it should be understood that such order is exemplary. Thus, alternative embodiments may perform the operations in a different order, combine certain operations, overlap certain operations, etc.

Additionally, although the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method in a first device for providing smart functionality to a second device comprising:
obtaining, by the first device responsive to being physically coupled with the second device via a physical interface, a device driver for the second device, wherein the first device and the second device are detachable;
receiving, by the first device, one or more commands from a user to configure the second device to perform one or more actions; and
causing, by the first device over the physical interface using the device driver, the second device to perform the one or more actions according to the received command.

2. The method of claim 1, wherein obtaining the device driver comprises:
receiving, by the first device via the physical interface of the second device, the device driver for the second device.

3. The method of claim 1, wherein obtaining the device driver comprises:
receiving, at the first device via a separate interface, the device driver for the second device.

4. The method of claim 3, wherein the separate interface is a wireless network interface, and wherein the device driver for the second device is received from a user device of the user.

5. The method of claim 4, wherein the received one or more commands from the user are received from the user device of the user via the wireless network interface, wherein the one or more commands were originated by the user device responsive to the user utilizing an application executed by the user device allowing the user to control the second device.

6. The method of claim 1, wherein obtaining the device driver comprises:
obtaining, by the first device, an identifier of the second device;
transmitting, by the first device via a separate interface, a request message carrying a request for the device driver, wherein the request includes the identifier of the second device; and
receiving, at the first device via the separate interface, the device driver for the second device.

7. The method of claim 1, wherein the second device is a consumer device that does not include a processor.

8. The method of claim 7, wherein the second device is manufactured by a separate entity than an entity that manufactured the first device.

9. The method of claim 1, further comprising:
receiving, by the first device, one or more additional commands from the user to configure a third device to perform one or more additional actions, wherein the one or more additional actions are to be performed by the third device at a time as when the second device performs the one or more actions or after the time when the second device performs the one or more actions; and
causing, by the first device over a wireless interface, the third device to perform the one or more additional actions at or after the time according to the received one or more additional commands.

10. The method of claim 1, wherein the first device further comprises one or more user input elements allowing the user to provide user input to the first device, and wherein the one or more commands are received from the user via the one or more user input elements.

11. A non-transitory computer-readable storage medium having instructions which, when executed by one or more processors of a first device, cause the first device to provide smart functionality to a second device by performing operations comprising:
obtaining, responsive to being physically coupled with the second device via a physical interface, a device driver for the second device, wherein the first device and the second device are detachable;
receiving one or more commands from a user to configure the second device to perform one or more actions; and
causing, over the physical interface using the device driver, the second device to perform the one or more actions according to the received command.

12. The non-transitory computer-readable storage medium of claim 11, wherein obtaining the device driver comprises:
receiving via the physical interface of the second device, the device driver for the second device.

13. The non-transitory computer-readable storage medium of claim 11, wherein obtaining the device driver comprises:
receiving, via a separate interface, the device driver for the second device.

14. The non-transitory computer-readable storage medium of claim 13, wherein the separate interface is a wireless network interface, and wherein the device driver for the second device is received from a user device of the user.

15. The non-transitory computer-readable storage medium of claim 14, wherein the received one or more commands from the user are received from the user device of the user via the wireless network interface, wherein the one or more commands were originated by the user device responsive to the user utilizing an application executed by the user device allowing the user to control the second device.

16. The non-transitory computer-readable storage medium of claim 11, wherein obtaining the device driver comprises:
obtaining an identifier of the second device;
transmitting, via a separate interface, a request message carrying a request for the device driver, wherein the request includes the identifier of the second device; and
receiving, via the separate interface, the device driver for the second device.

17. A first device to provide smart functionality to a second device, the first device comprising:
a physical interface to physically and communicatively couple the first device with a second device, wherein the first device and the second device are detachable;
one or more processors; and
a non-transitory computer-readable storage medium having instructions which, when executed by the one or more processors, cause the first device to perform operations comprising:
obtaining, responsive to being physically coupled with the second device via the physical interface, a device driver for the second device;
receiving one or more commands from a user to configure the second device to perform one or more actions; and
causing, over the physical interface using the device driver, the second device to perform the one or more actions according to the received command.

18. The first device of claim 17, wherein obtaining the device driver comprises:
receiving via the physical interface of the second device, the device driver for the second device.

19. The first device of claim 17, wherein obtaining the device driver comprises:
receiving, via a separate interface, the device driver for the second device.

20. The first device of claim 19, wherein the separate interface is a wireless network interface, and wherein the device driver for the second device is received from a user device of the user.

21.-24. (canceled)
